(19) United States
(12) Patent Application Publication
(10) Pub. No.: US 2017/0186332 A1
(43) Pub. Date: Jun. 29, 2017

(54) COMMUNICATION METHOD, COMMUNICATION DEVICE AND STORAGE MEDIUM

(71) Applicant: CASIO COMPUTER CO., LTD., Tokyo (JP)

(72) Inventor: Yuichi ICHIKAWA, Tokyo (JP)

(73) Assignee: CASIO COMPUTER CO., LTD., Tokyo (JP)

(21) Appl. No.: 15/278,734

(22) Filed: Sep. 28, 2016

(30) Foreign Application Priority Data
Dec. 25, 2015 (JP) 2015-254212
Jul. 6, 2016 (JP) 2016-134217

(51) Int. Cl. G09B 7/077; G06F 17/30

(52) U.S. Cl. CPC G09B 7/077; G06F 17/30657

(57) ABSTRACT

A communication method of a communication device including a display and a communication unit communicating with a terminal, comprises: registering (i) a plurality of character string data items selected from text data by user's operations, and (ii) correct order data which is selection order data of the plurality of character string data items, in association with each other; generating order data which is different from the registered correct order data in the order, as question order data of the plurality of selected character string data items; transmitting the generated question order data and the plurality of selected character string data items, in association with each other, to a terminal; receiving answer order data which is order data of answers to the plurality of selected character string data items, from the terminal; and determining the received answer order data based on the registered correct order data.

### CROSS-REFERENCE TO RELATED APPLICATIONS

This application is based upon and claims the benefit of priority from the prior Japanese Patent Application Nos. 2015-254212, filed on Dec. 25, 2015, and 2016-134217, filed on Jul. 6, 2016, and the entire contents of which are incorporated herein by reference.

### BACKGROUND OF THE INVENTION

Field of the Invention

The present invention relates to a communication method, a communication device and a storage medium.

Description of the Related Art

For example, in JP-A-H10-123924, there is proposed a memorization-learning support device, which can be applied to document processing devices such as PCs or electronic organizers, and sets fill-in-the-blank questions by selecting some character strings as memorization-learning objects from input sentences and hiding the selected character strings, and responses to instructions for calling the solutions of those fill-in-the-blank questions, thereby supporting memorization-learning of learners.

According to the invention disclosed in JP-A-H10-123924, the memorization-learning support device searches for a character string of a designated area from input documents stored in a document buffer, and displays a symbol string (a character string to be a memorization-learning object) of preset symbol information, in place of the searched character string. This is triggered by a keyboard or pen input.

Recently, with the spread of smart devices, attention has been being focused on teaching using information and communication technologies (ICTs) for education, and more and more schools have been working on promotion of class efficiency, for example, by a teaching style using tablet terminals.

Also, since smart devices having a near field communication function such as Bluetooth (a trademark), Wi-Fi (a trademark), or NFC (a trademark) have appeared, and such communication devices having the near field communication function can perform communication with one another, it is predicted that, from now on, in order to improve the efficiency of teaching and learning in schools, and improve the efficiency of leaning in compliance education which is conducted in a company or the like, the demand for applying the near field communication function to many educational devices, such as electronic dictionaries, scientific calculators, and tablets, which are used in schools, tablet terminals, and smart phones will increase.

The present invention was made in view of the above described circumstances, and an object of the present invention is to provide a communication device, a communication method, and a program capable of improving the efficiency of learning.

A communication method of a communication device including a display and a communication unit which communicates with a terminal, comprises: registering (i) a plurality of character string data items selected from text data displayed on the display by user's operations, and (ii) correct order data which is selection order data of the plurality of character string data items, in association with each other; generating order data which is different from the registered correct order data in the order, as question order data of the plurality of selected character string data items; transmitting the generated question order data and the plurality of selected character string data items, in association with each other, to a terminal by the communication unit; receiving answer order data which is order data of answers to the plurality of selected character string data items, from the terminal by the communication unit; and determining the received answer order data based on the registered correct order data.

### BRIEF DESCRIPTION OF THE DRAWINGS

FIGS. 1A and 1B are views illustrating an example of use of communication devices of embodiments according to the present invention.

FIG. 2 is a view illustrating another example of use of communication devices of embodiments according to the present invention.

FIG. 3 is a block diagram illustrating the configurations of a communication device and a student terminal according to a first embodiment.

FIG. 4 is a view for explaining a case of setting a world history question according to the first embodiment.

FIG. 5 is a view for explaining a world history question which is displayed on a student terminal.

FIG. 6 is a view for explaining the result of correct-answer/incorrect-answer determination on an answer which is displayed on a communication device.

FIG. 7 is a view for explaining the result of correct-answer/incorrect-answer determination on an incorrect answer which is displayed on the student terminal.

FIG. 8 is a view for explaining the result of correct-answer/incorrect-answer determination on no answer which is displayed on the student terminal.

FIG. 9 is a flow chart illustrating a portion of an operation of the communication device of the first embodiment.

FIG. 10 is a flow chart illustrating the other portion of the operation of FIG. 9.

FIG. 11 is a flow chart illustrating an operation of the student terminal of the first embodiment.

FIG. 12 is a view for explaining a list of correct-answer/incorrect-answer determination results which is displayed on the communication device.

FIG. 13 is a flow chart illustrating an operation of a communication device of a second embodiment according to the present invention.

FIG. 14 is a flow chart illustrating the other portion of the operation of FIG. 13.

FIG. 15 is a view for explaining a case of setting an English question according to the second embodiment.

FIG. 16 is a view for explaining an English question which is displayed on the student terminal.

FIG. 17 is a view for explaining the result of correct-answer/incorrect-answer determination on an incorrect answer which is displayed on the student terminal.

FIG. 18 is a view for explaining another example of the communication device and the student terminal and another example of use of them according to the present invention.

FIG. 19 is a view illustrating a case of displaying even hidden texts (character strings) on the student terminal according to the present invention.

### DETAILED DESCRIPTION OF THE INVENTION

Hereinafter, modes for carrying out the present invention (hereinafter, referred to as “embodiments”) will be described in detail with reference to the accompanying drawings. Throughout the description of embodiments, elements identical to each other will be denoted by the same reference symbol.

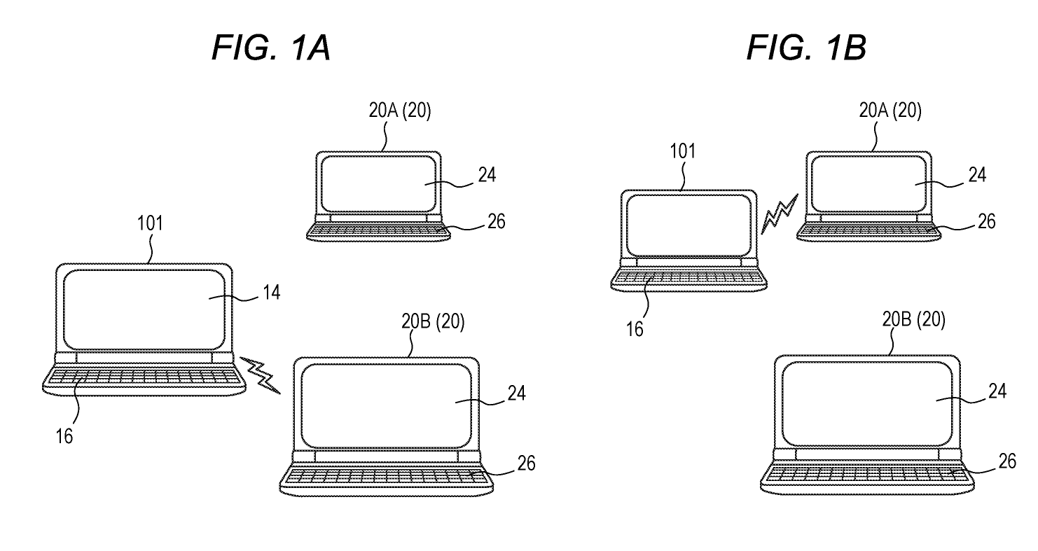

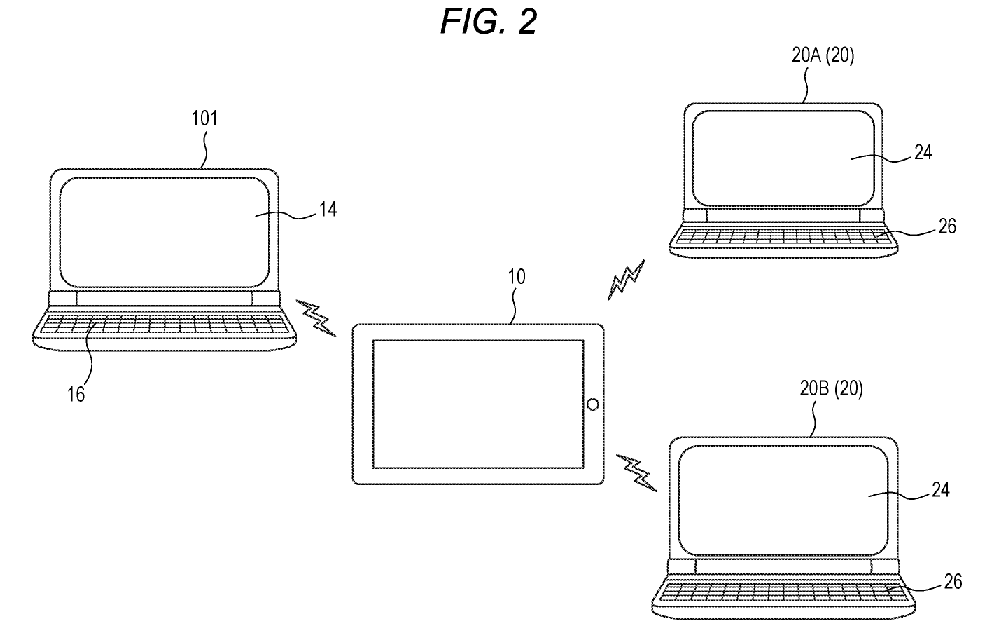

FIGS. 1A, 1B, and 2 are views illustrating examples of use of a communication device 101 of embodiments according to the present invention.

The communication device 101 of the embodiments according to the present invention has the form of an electronic dictionary. Also, the communication device 101 has a near field communication function such that, if the communication device 101 is brought close to a terminal capable of near field communication with the communication device 101, the communication device can perform communication with the corresponding terminal, as will be described below in detail. Also, as a method of detecting whether the communication device is within a predetermined distance from the terminal, various methods such as (A) a method of detecting whether the strength of Bluetooth (a trademark) communication is equal to or higher than a predetermined communication level, (B) a method of detecting the locations of both terminals by a GPS while performing Wi-Fi communication, and detecting whether their locations are within a predetermined distance, based on the information on the locations of the terminals, (C) a method of providing acceleration sensors to both terminals, and determining that both terminals are within a predetermined distance (both terminals are in contact with each other) if both terminals detect impacts attributable to bumping, almost at the same time, by the acceleration sensors, and (D) a method of detecting whether both terminals are within a predetermined distance, based on the communication signal intensity of NFC can be used.

Therefore, as shown in FIG. 1A, if the communication device 101 is brought close to a terminal 20B capable of near field communication, the communication device 101 performs communication with the terminal 20B. Meanwhile, as shown in FIG. 1B, if it is detected by any one of various methods described above that the communication device 101 is close to a terminal 20A capable of near field communication, the communication device 101 performs communication with the terminal 20A.

Also, in the present embodiment, the terminal 20A and the terminal 20B have the form of an electronic dictionary.

However, the communication device 101 of the present embodiment is not limited to such a use form that the communication device directly performs near field communication with the terminal 20A or the terminal 20B. As shown in FIG. 2, the communication device may perform communication with the terminal 20A or the terminal 20B through a tablet terminal 10 in such a manner that the communication device performs near field communication with a tablet terminal 10 capable of near field communication and the tablet terminal 10 performs communication with the terminal 20A or the terminal 20B.

Although the communication device 101 will be described in detail with concrete examples, it is also possible to implement the communication device 101 of the present invention in the form of a tablet terminal 10 by providing a function to be described below to the tablet terminal 10.

Hereinafter, a mode in which the communication device 101 directly performs near field communication with the terminal 20A or the terminal 20B if being brought close to the terminal 20A or the terminal 20B as shown in FIGS. 1A and 1B will be described as an example.

Also, hereinafter, as a concrete use example, a case where the communication device 101 is a device for a teacher during class or the like, and the terminal 20A and the terminal 20B are terminals for students will be described.

Therefore, hereinafter, the terminal 20A and the terminal 20B will be referred to simply as student terminals 20.

### First Embodiment

The communication device 101 has various functions, such as a function of setting questions to be given to the student terminals 20, a function of performing correct-answer/incorrect-answer determination on answers transmitted from the student terminals 20, a function of transmitting the correct-answer/incorrect-answer determination results to the student terminals 20, and a function of providing search permission information for permitting students to search for and browse information on clues to the questions, to the student terminals 20.

Meanwhile, the student terminals 20 have various functions such as a function of receiving questions, a function of transmitting students' answers, and a function of allowing students to search for and browse information to be clues to the questions if search permission information is received from the communication device 101.

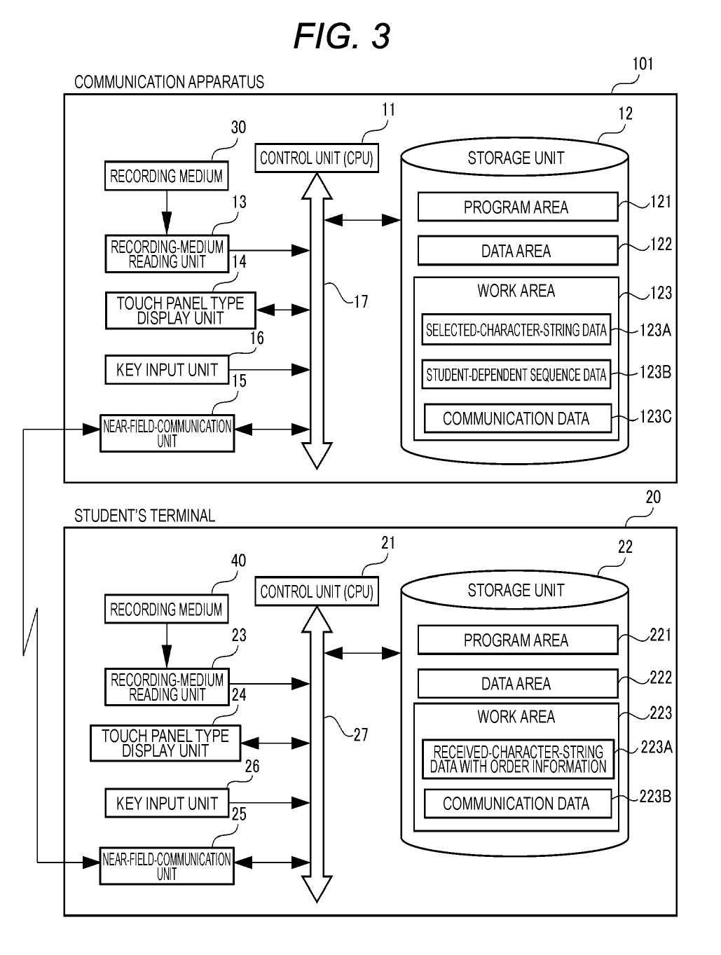

FIG. 3 is a block diagram illustrating the configurations of the communication device 101 and a student terminal 20.

Hereinafter, the configurations of the communication device 101 and a student terminal 20 will be described with reference to the block diagram of FIG. 3.

The configuration of the communication device 101 will be first described, and then the configuration of a student terminal 20 will be described.

(Configuration of Communication Device)

As shown in FIG. 3, the communication device 101 includes a control unit (CPU) 11, a storage unit 12, a recording-medium reading unit 13, a touch panel type display unit 14, a near field communication unit 15, and a key input unit 16, which are connected to a bus 17. Also, it is possible to detect whether the communication device 101 and a student terminal 20 (terminals) are within a predetermined distance, by near field communication of the near field communication unit 15, and it is also possible to provide acceleration sensors to the communication device 101 and the student terminals 20, respectively, and detect that the communication device and a student terminal are within a predetermined distance if they detect impacts attributable to bumping almost at the same time. Alternatively, it is possible to provide a GPS to the communication device 101 and the student terminals 20 (terminals), and detect whether the communication device and a student terminal are within a predetermined distance, based on information on their locations.

(Key Input Unit)

As shown in FIGS. 1A and 1B, the key input unit 16 includes key switches, buttons, and the like arranged in a matrix.

A user (the teacher) can perform an operation of pressing some of the key switches, the buttons, and the like of the key input unit 16, thereby performing various operations such as setting and inputting on the communication device 101.

(Display Unit)

The touch panel type display unit 14 is a part for performing a variety of display such as display of a setting menu for the user (the teacher) to perform various settings on the communication device 101, display of dictionaries or texts for setting questions to be given to the student terminals 20, display of answers received from the student terminals 20, and display of the results of correct-answer/incorrect-answer determination on the answers.

The touch panel type display unit 14 according to the present embodiment is integrally configured by laminating a touch panel composed of a transparent electrode circuit pattern on a surface of a liquid crystal display device, and has a touch panel function.

Therefore, the touch panel type display unit can be used not only to display dictionaries and texts for setting questions to be given to the student terminals 20 but also to perform editing for setting questions.

(Storage Unit)

The storage unit 12 is configured by a semiconductor memory such as a SRAM, a DRAM, or a flash memory, and has various areas such as a program area 121, a data area 122, and a work area 123.

In the program area 121, a learning support program for making the control unit (CPU) 11 function as various means necessary for performing processes which the communication device 101 which is a device for the teacher should perform is stored.

Also, in the data area 122, various data such as a world history dictionary and English texts necessary for setting questions is stored.

Further, in the work area 123, various data such as data (selected-character-string data 123A, student-terminal-dependent sequence data 123B, and communication data 123C) necessary to give questions to the student terminals 20 or after correct-answer/incorrect-answer determination on answers received from the student terminals 20 is stored, as will be described below in detail.

(Recording-Medium Reading Unit)

The recording-medium reading unit 13 is a part for reading data of a recording medium 30 such as a CD-ROM or a DVD, and is used, for example, to load data or the like into the storage unit 12.

For example, in a case where the data of the recording medium 30 is a learning support program (including update), the learning support program of the recording medium 30 is read by the recording-medium reading unit 13, and is stored in the program area 121 of the storage unit 12 through the bus 17.

Also, in a case where the data of the recording medium 30 is data such as a world history dictionary or English texts, the data of the recording medium 30, such as the world history dictionary or the English texts, is read by the recording-medium reading unit 13, and is stored in the data area 122 of the storage unit 12 through the bus 17.

(Near Field Communication Unit)

The near field communication unit 15 can use various communication systems such as Bluetooth (a trademark) communication, Wi-Fi communication, and NFC. Also, it is possible to detect whether the communication device 101 and a student terminal 20 (terminals) are within a predetermined distance, based on the strength of near field communication of the near field communication unit 15, and it is also possible to provide acceleration sensors to the communication device 101 and the student terminals 20, respectively, and detect that the communication device and a student terminal are within a predetermined distance if they detect impacts attributable to bumping almost at the same time. Alternatively, it is possible to provide a GPS to the communication device 101 and the student terminals 20 (terminals), and detect whether the communication device and a student terminal are within a predetermined distance, based on information on their locations. In the present embodiment, the near field communication unit 15 of the communication device 101 is a part having a built-in NFC (a trademark) reader/writer and serving as an interface for near field communication with other devices such as the student terminals 20 having built-in NFC tags, and performs data communication with the built-in NFC tags based on the NFC standard.

Also, the NFC reader/writer has a built-in coil for supplying electromotive force to a communication partner device having a NFC tag. If the NFC reader/writer gets close to the NFC tag, the NFC reader/writer obtains a response from the NFC tag exposed to an electromagnetic wave, thereby reading and writing data.

Further, each student terminal 20 has an NFC tag. Therefore, if the communication device 101 gets close to a student terminal 20, the communication device 101 and the student terminal 20 can perform NFC (hereinafter, referred to as short-range communication).

(Control Unit)

The control unit (CPU) 11 is configured by a CPU (a central processing unit) or the like, and controls the operation of the entire communication device 101 according to various programs (such as a learning support program) stored in the storage unit 12, and functions as various means for performing various processes of the operation of the communication device 101.

Hereinafter, which means the control unit 11 functions as will be described with concrete examples.

(Character String Registering Means)

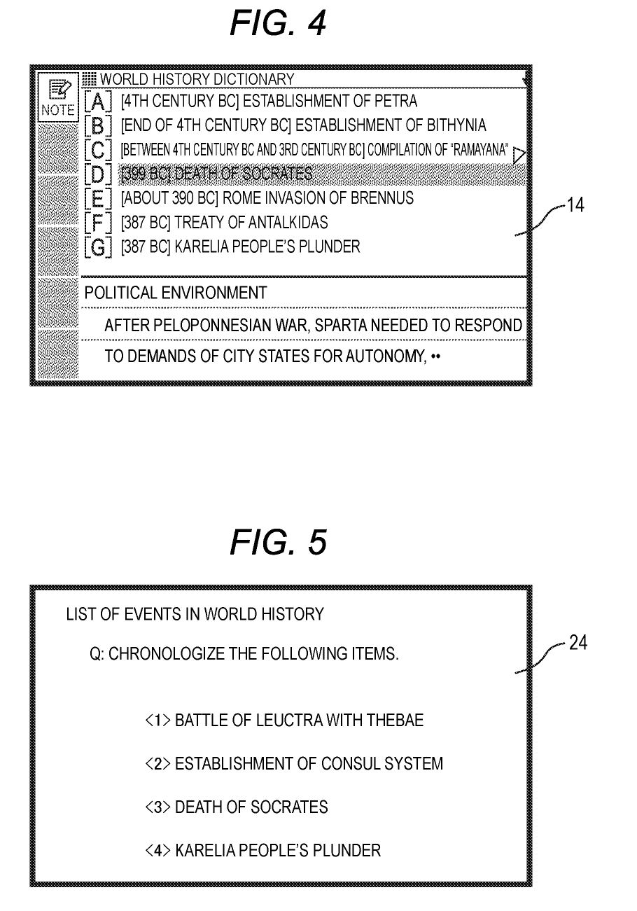

For example, if a case of setting a question about rearranging world history events in chronological order is taken as an example, in a state where texts of the titles of events of a world history dictionary for setting a question are displayed on the touch panel type display unit 14 as shown in FIG. 4, the user (the teacher) sequentially selects the character strings of the titles of events (hereinafter, also referred to as the character strings of events) for a question with a touch pan.

For example, in FIG. 4, a character string “DEATH OF SOCRATES” of an event that happened in 399 BC is selected.

Also, although not shown, it is assumed to scroll the screen by operating the key input unit 16, and sequentially select a character string “KARELIA PEOPLE'S PLUNDER” of an event that happened in 387 BC, and sequentially select a character string “BATTLE OF LEUCTRA WITH THEBAE” of an event that happened in 371 BC, and finally select a character string “ESTABLISHMENT OF CONSUL SYSTEM” of an event that happened in 367 BC.

Then, the control unit 11 functions as a character string registering means for registering the four character strings (“DEATH OF SOCRATES”, “KARELIA PEOPLE'S PLUNDER”, “BATTLE OF LEUCTRA WITH THEBAE”, and “ESTABLISHMENT OF CONSUL SYSTEM”) which are character strings sequentially selected by the user's (teacher's) operations, and the order in which those character strings were selected, in an area for selected-character-string data 123A included in the work area 123 of the storage unit 12.

As a result, as selected-character-string data 123A, the selected character strings and predetermined order data (correct order data (1) to (4)) are stored in association with each other, like (1) “DEATH OF SOCRATES”, (2) “KARELIA PEOPLE'S PLUNDER”, (3) “BATTLE OF LEUCTRA WITH THEBAE”, and (4) “ESTABLISHMENT OF CONSUL SYSTEM”.

At this time, the predetermined order data may be registered as data on the display order of the selected character strings in text.

In the present embodiment, the character strings of the events are displayed in chronological order.

Therefore, even if the user (the teacher) selects character strings in the order from top to bottom, correct order data is registered appropriately for the sequence (the chronological order of the character strings in text).

Meanwhile, in a case where the text is history explanation text, for explanation, the character strings which are keywords do not necessarily need to be written in chronological order.

In that case, the predetermined order data may be generated in the selection order. In this case, if the teacher appropriately selects keywords (character strings) in chronological order, correct order data is appropriately registered.

(Question Order Data Generating Means Using Changing Sequence)

The control unit 11 functions as a question order data generating means for generating question order data by changing the correct order data (the sequence of the character strings) registered by the character string registering means in an order different from the original order (for example, randomly). For example, the control unit randomly changes the sequence of the character strings (the question order data), for example, like <1>“BATTLE OF LEUCTRA WITH THEBAE (3)”, <2>“ESTABLISHMENT OF CONSUL SYSTEM (4)”, <3>“DEATH OF SOCRATES (1)”, and <4>“KARELIA PEOPLE'S PLUNDER (2)”, thereby generating a question about rearrangement in chronological order.

Also, in the above description, the numbers in the angle brackets represent the order obtained by changing the sequence, and the numbers in the round brackets in the double quotation marks represent the correct sequence which is not displayed in principle.

Also, it is possible to change the sequence of the character strings based on a certain rule, instead of randomly changing the sequence of the character strings. Also, in a case of randomly changing the sequence of the character strings, the question order data may become the same order as the original correct order by chance. In this case, it is preferable to re-change the sequence of the character strings until the question order data becomes an order different from the correct order.

Thereafter, the question set as described above is transmitted to the student terminals 20, and as shown in FIG. 5, for example, each student terminal 20 receives the question, and the question about rearranging <1>“BATTLE OF LEUCTRA WITH THEBAE”, <2>“ESTABLISHMENT OF CONSUL SYSTEM”, <3>“DEATH OF SOCRATES”, and <4>“KARELIA PEOPLE'S PLUNDER” in chronological order is displayed on a touch panel type display unit 24.

The order of the correct answer to the question should be <3>“DEATH OF SOCRATES (1)”, <4>“KARELIA PEOPLE'S PLUNDER (2)”, <1>“BATTLE OF LEUCTRA WITH THEBAE (3)”, and <2>“ESTABLISHMENT OF CONSUL SYSTEM (4)”.

Also, in order to determine whether the answer of the student is correct or not, it is necessary to make it possible to determine whether the correct sequence has been received as the answer from the student terminal 20. For this reason, after the control unit 11 randomly changes the sequence, it registers the correct answer, that is, [1]<3>“DEATH OF SOCRATES (1)”, [2]<4>“KARELIA PEOPLE'S PLUNDER (2)”, [3]<1>“BATTLE OF LEUCTRA WITH THEBAE (3)”, and [4]<2>“ESTABLISHMENT OF CONSUL SYSTEM (4)”, as student-terminal-dependent correct-answer data, in an area for student-terminal-dependent sequence data 123B included in the work area 123 of the storage unit 12.

In this case, the student-terminal-dependent correct-answer data may be only “<3><4><1><2>” associated with the terminal ID unique to the student terminal.

Also, it is possible to receive answer order data associated with data on the plurality of selected character string, as answer order data from the student.

Alternatively, it is possible to receive answer data including answer order data and correct order data associated with each other (for example, <3>(1), <4>(2), <1>(3), <2>(4)), from the student.

As described above, if original correct-order-data correspondence information is included in the answer order data from the student, the communication device 101 does not need to register student-terminal-dependent correct-answer data.

(Character-String Transmitting Means)

If the distance of the communication device 101 from any one of the plurality of student terminals 20 becomes a predetermined distance or less, whereby short-range communication becomes possible, the control unit 11 detects that, and functions as a character-string transmitting means for transmitting the character strings rearranged in a random sequence, to the corresponding student terminal 20, thereby transmitting <1>“BATTLE OF LEUCTRA WITH THEBAE”, <2>“ESTABLISHMENT OF CONSUL SYSTEM”, <3>“DEATH OF SOCRATES”, and <4>“KARELIA PEOPLE'S PLUNDER”.

Specifically, data for performing display as shown in FIG. 5 on the touch panel type display unit 24 of the student terminal 20 is transmitted.

Also, if the character strings of the same sequence are transmitted to every student terminal 20, it is concerned that some students may cheat off neighboring students.

For this reason, specifically, it is preferable to perform transmission in the following procedure.

First, when the communication device 101 gets close to any one of the plurality of student terminals 20, whereby short-range communication becomes possible, the control unit 11 functions as a terminal identifying means for identifying the corresponding student terminal 20, thereby acquiring the terminal ID of the student terminal 20 capable of communication.

After acquiring the terminal ID of the student terminal 20, the control unit 11 sequentially functions as a sequence changing means and the character-string transmitting means, thereby performing a process of randomly changing the sequence of the character strings, and registering the sequence of the correct answer as student-terminal-dependent sequence data of the work area 123 of the storage unit 12, in association with the terminal ID. Thereafter, the control unit transmits the character strings rearranged in the random sequence, to the student terminal 20.

In this case, whenever the control unit tries to transmit the character strings to a student terminal 20, the process of randomly changing the sequence of the character strings is performed. Therefore, the correct sequences of questions given to neighboring students are different, and it is possible to prevent cheating.

Also, in this case, it is possible to change the sequence using random numbers or the like, not based on a rule. Also, even in a case of changing the sequence based on some rules, it is possible to prepare a plurality of rules for changing the sequence, and perform switching to a rule for changing the sequence whenever the sequence is changed.

If a question is given in the above described manner, the control unit 11 registers information representing that the corresponding question has been given, as communication data, in association with the terminal ID of a student terminal 20 which is the transmission destination of the character strings, in the work area 123 of the storage unit 12.

(Answer Order Data Receiving Means)

If the communication device 101 gets close to a student terminal 20 again, whereby short-range communication becomes possible, first, the control unit 11 acquires the terminal ID of the student terminal 20, and checks the communication data.

In other words, since the expression “again” does not guarantees that the student terminal 20 close to the communication device and capable of communication is a student terminal 20 having already received a question, and communication with the communication device is actually the second communication, the control unit checks communication data corresponding to the acquired terminal ID, thereby determining whether a question has been given.

If a question has been given, the control unit functions as an answer receiving means (an answer order data receiving means) for receiving information for obtaining the character string sequence of the answer from the student terminal 20, thereby acquires information for obtaining the character string sequence of the answer (the order data of the answer).

The information for obtaining the character string sequence of the answer is not limited to order information like [1]<3>, [2]<4>, [3]<1>, and [4]<2>. In a case where the character strings to be transmitted from the student terminal 20 are sorted in ascending order, and are transmitted in the order of [1], [2], [3], and [4], the order in which the character strings are received can be information for obtaining the character string sequence of the answer.

Even if the character strings are received in the above described manner, since information representing what are the numbers assigned to the character strings transmitted to the student is stored as the student-terminal-dependent sequence data 123B in the work area 123 of the storage unit 12, it is possible to perform correct-answer/incorrect-answer determination on the student's answer by referring to the student-terminal-dependent sequence data.

If it is possible to safely receive information for obtaining the character string sequence of the answer from the student terminal 20, the control unit 11 registers information representing that the answer has been received, as communication data 123C, in the work area 123 of the storage unit 12.

However, even by this communication, it may not be possible to receive information for obtaining the character string sequence of the answer from the student terminal 20.

The reason is that a student terminal 20 having no answer and incapable of transmitting information for obtaining a character string sequence as an answer can exist.

Therefore, in a case where it is impossible to receive information for obtaining a character string sequence as an answer from a student terminal 20, the control unit 11 registers information representing that it has been impossible to receive any answer, as communication data.

(Determining Means)

If receiving information for obtaining a character string sequence as an answer from a student terminal 20, the control unit 11 functions as a determining means for performing correct-answer/incorrect-answer determination by comparing the character string sequence information rechargeable battery the answer receiving means with the character string sequence registered by the character string registering means, thereby determining whether the answer is correct or not.

Specifically, since the sequence of the correct answer (the correct order data) has been prepared as the student-terminal-dependent sequence data 123B in the work area 123 of the storage unit 12 such that comparison with the character string sequence registered by the character string registering means is possible, the control unit needs only to determine whether the character string sequence of the answer is the same as the registered sequence, by comparison.

Subsequently, the control unit 11 stores the result of correct-answer/incorrect-answer determination on the answer, as a student-terminal-dependent correct-answer/incorrect-answer determination result (not shown) in the work area 123 of the storage unit 12, and displays the correct-answer/incorrect-answer determination result on the touch panel type display unit 14.

For example, in the above described example, if the sequence of the answer is <3>“DEATH OF SOCRATES (1)”, <4>“KARELIA PEOPLE'S PLUNDER (2)”, <1>“BATTLE OF LEUCTRA WITH THEBAE (3)”, and <2>“ESTABLISHMENT OF CONSUL SYSTEM (4)”, the answer is correct.

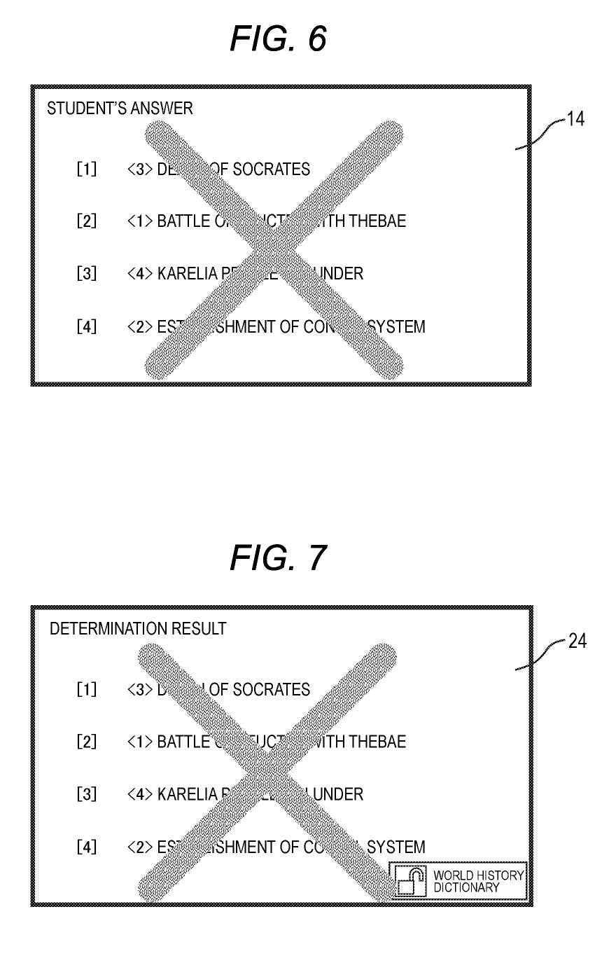

However, in a case where an answer of a student is [1]<3>“DEATH OF SOCRATES (1)”, [2]<1>“BATTLE OF LEUCTRA WITH THEBAE (3)”, [3]<4>“KARELIA PEOPLE'S PLUNDER (2)”, and [4]<2>“ESTABLISHMENT OF CONSUL SYSTEM (4)”, the answer is incorrect. At this time, the correct-answer/incorrect-answer determination result as shown in FIG. 6 is displayed on the touch panel type display unit 14.

In FIG. 6, only one correct-answer/incorrect-answer determination result is displayed on the touch panel type display unit 14. However, since there are the correct-answer/incorrect-answer determination results of a plurality of students in the communication device 101 which is a device for the teacher, naturally, the communication device also has a function of displaying a list of them on the touch panel type display unit 14.

Further, if the control unit 11 receives information for obtaining a character string sequence as an answer from a student terminal 20, it immediately transmits the correct-answer/incorrect-answer determination result to the student terminal 20.

(Information Providing Means)

Also, the control unit 11 functions as an information providing means for transmitting character string search permission information to the student terminals 20.

Here, it is assumed that setting has been performed as a default such that, in a case where there is an unanswered portion or an incorrect portion, or in a case where it is impossible to receive an answer, or there is no answer, the control unit information (search permission information) for permit a student to search the world history dictionary for the character strings of the question (the titles of the world history events).

Therefore, for example, to a student terminal 20 having transmitted an incorrect answer as shown in FIG. 6, the control unit transmits the correct-answer/incorrect-answer determination result to be displayed on the touch panel type display unit 24, and transmits information for permitting world history dictionary search subsequently to the correct-answer/incorrect-answer determination result.

As a result, as shown in FIG. 7, the correct-answer/incorrect-answer determination result is displayed on the touch panel type display unit 24 of the student terminal 20, with world history dictionary search permission information displayed on the lower right side of the correct-answer/incorrect-answer determination result.

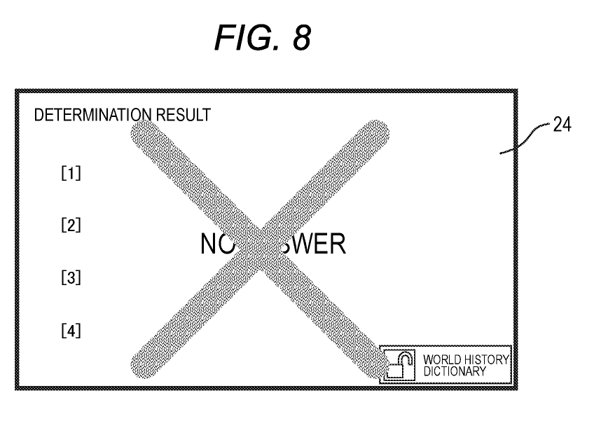

Also, even in a case where it is impossible to receive information for obtaining a character string sequence as an answer from a student terminal 20, when it is determined that it is impossible to receive any answer, data as shown in FIG. 8 is transmitted to the student terminal 20, such that the data is displayed on the touch panel type display unit 24 of the student terminal 20 with world history dictionary search permission information displayed on the lower right side.

(Configuration of Student Terminal)

Now, the configuration of a student terminal 20 will be described.

As shown in FIG. 3, similarly to the communication device 101, the student terminal 20 includes a control unit 21, a storage unit 22, a recording-medium reading unit 23, a touch panel type display unit 24, a near field communication unit 25, and a key input unit 26, which are connected to a bus 27. The near field communication unit 25 can use various communication systems such as Bluetooth (a trademark) communication, Wi-Fi communication, and NFC. Also, it is possible to detect whether the communication device 101 and a student terminal 20 (terminals) are within a predetermined distance, based on the strength of near field communication of the near field communication unit 25, and it is also possible to provide acceleration sensors to the communication device 101 and the student terminals 20, respectively, and detect that the communication device and a student terminal are within a predetermined distance if they detect impacts attributable to bumping almost at the same time. Alternatively, it is possible to provide a GPS to the communication device 101 and the student terminals 20 (terminals), and detect whether the communication device and a student terminal are within a predetermined distance, based on information on their locations.

In the present embodiment, the student terminal 20 is different from the communication device 101, only in that the near field communication unit 15 has the NFC reader/writer, whereas the near field communication unit 25 has an NFC tag, and the basic software configuration of the student terminal 20 is substantially the same as that of the communication device 101.

Also, the main difference is that a learning support program is configured based on the contents which students should perform, and is stored in a data area 222.

Therefore, hereinafter the difference in the operation will be mainly described, and some of the same points as those of the communication device 101 cannot be described.

(Storage Unit 22)

Even in the student terminal 20, similarly, the storage unit has various areas such as a program area 221, the data area 222, and a work area 223, and in the program area 221, a learning support program is stored, and in the data area 222, and in various data such as a world history dictionary and English texts necessary for setting questions is stored.

However, the learning support program stored in the program area 221 restricts free access to the world history dictionary, the English texts, and the lie of the data area 222.

In other words, in a case where search permission information is received from the communication device 101 as described above, the learning support program permits access for the first time.

Also, in the work area 223, received-character-string data which is data on a question and the like given from the communication device 101 is stored.

Further, since the student terminal 20 basically needs only to be able to perform a passive operation with respect to the communication device 101, in the work area 223, as communication data 223B, only information for obtaining a character string sequence (answer order data) to be transmitted as an answer to the communication device 101 in response to an answer transmission request of the communication device 101 is stored.

Also, the control unit 21 mainly functions as some means such as a means of generating information for obtaining a character string sequence as an answer according to user's (student's) operations on the key input unit 26, a means for displaying a question received from the communication device 101, on the touch panel type display unit 24, and a means of displaying a correct-answer/incorrect-answer determination result received from the communication device 101, on the touch panel type display unit 24.

(Operations Between Communication Device and Student Terminal)

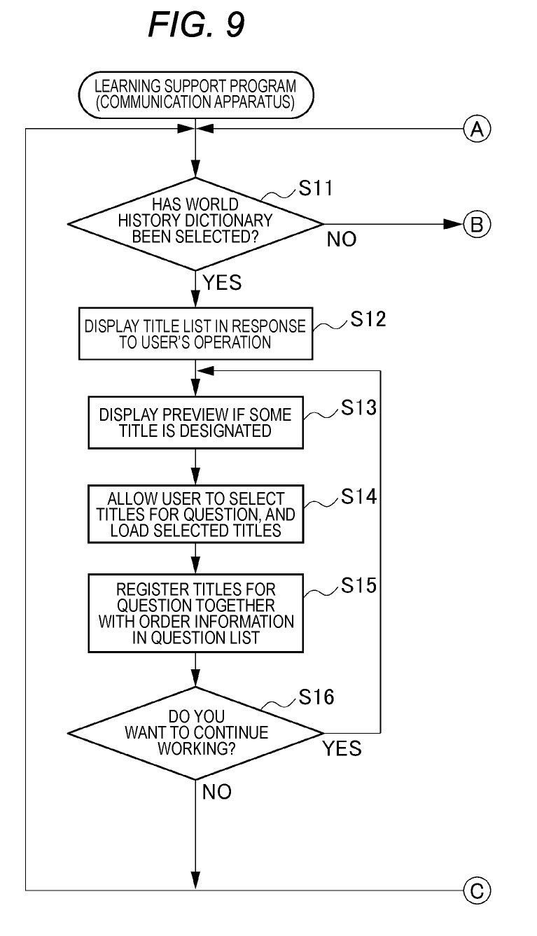

Although most of the operations between the communication device 101 and a student terminal 20 having the above described configurations have been already described, the corresponding operations will be confirmed with respect to flow charts shown in FIGS. 9 to 11.

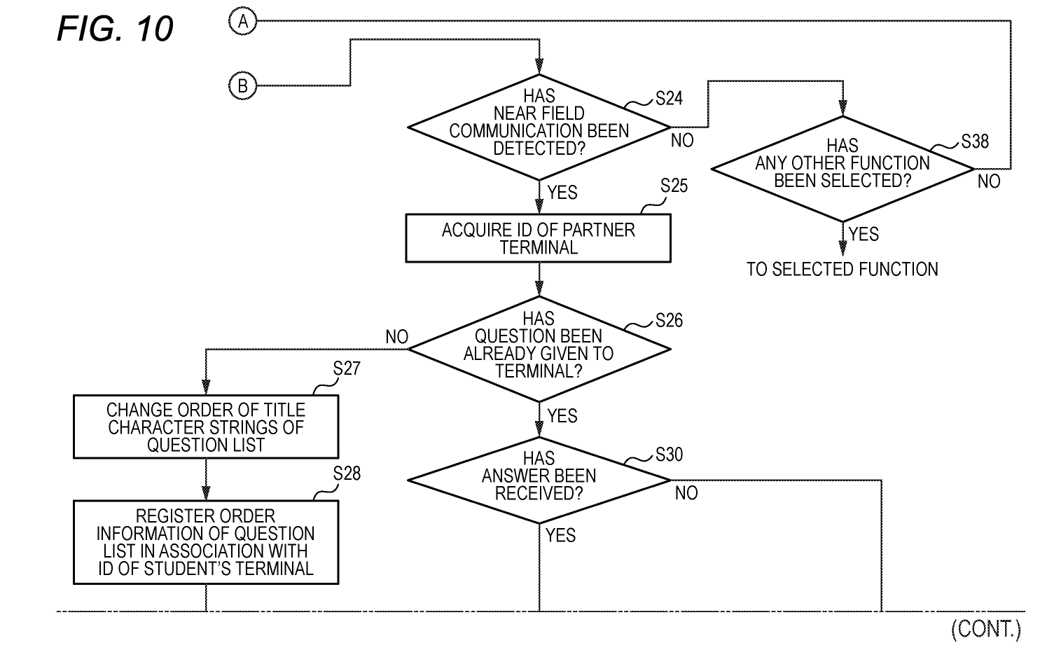

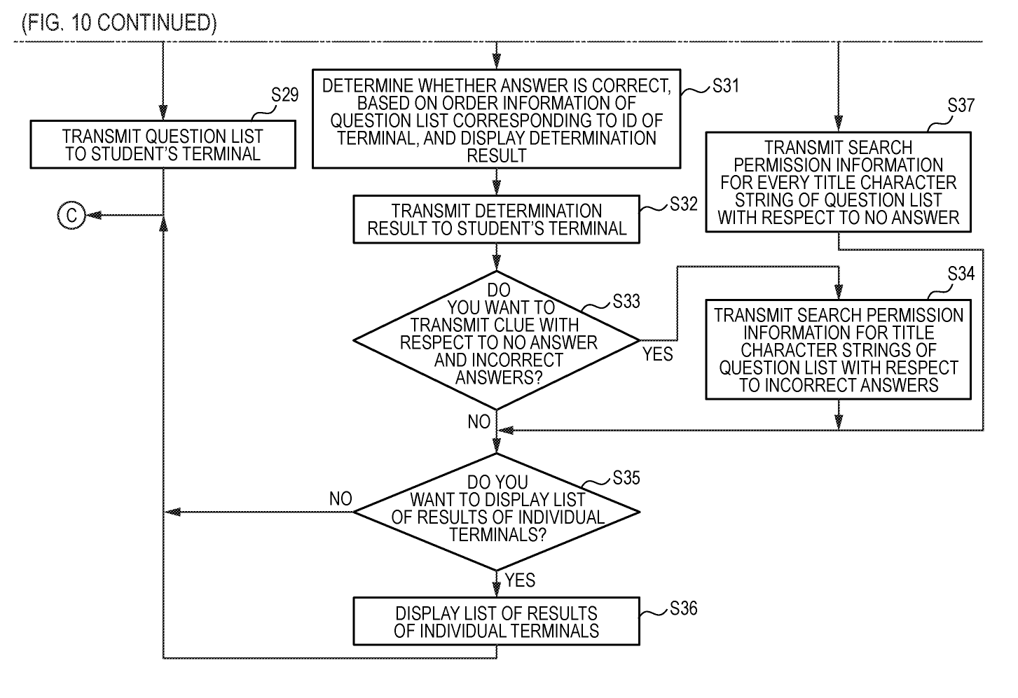

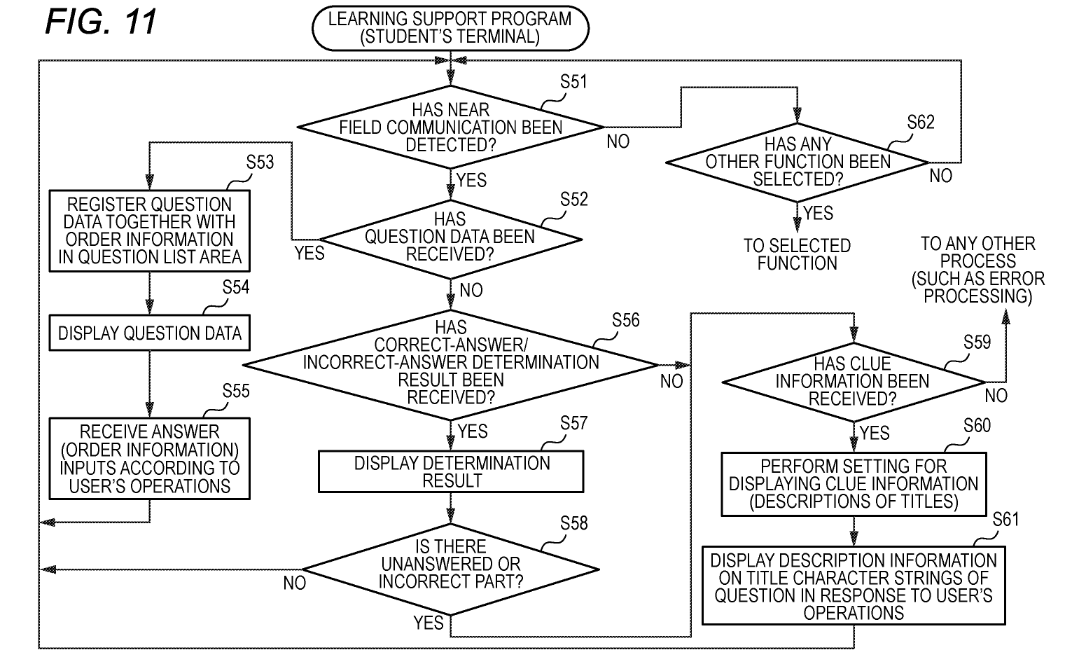

FIGS. 9 and 10 are flow charts for explaining the operation of the communication device 101, and FIG. 11 is a flow chart for explaining the operation of the student terminal 20.

(Operation of Communication Device)

First, the operation of the communication unit 25 will be described with reference to FIGS. 9 and 10.

As shown in FIG. 9, if the operation starts, in STEP S11, the control unit 11 determines whether the world history dictionary or the like has been selected. In a case where the world history dictionary and the like have not been selected (“NO” in STEP S11), in STEP S24, the control unit 11 determines whether short-range communication has been detected. In a case where short-range communication has not been detected (“NO” in STEP S24), in STEP S38, the control unit 11 determines whether any other function has been selected. In a case where any other function has not been selected (“NO” in STEP S38), the control unit 11 returns to STEP S11 in which the control unit determines whether the world history dictionary or the like has been selected.

In other words, the control unit 11 becomes a state in which it waits for any one event of selection of the world history dictionary or the like (STEP S11), detection of short-range communication (STEP S24), and selection of any other function (STEP S38) to occur.

In this state, if the world history dictionary or the like has been selected, the result of STEP S11 becomes “YES”, and in STEP S12, the control unit 11 controls the display unit 14 in response to user's (teacher's) operations such that the display unit displays a list of character strings of the titles of world history events as shown in FIG. 4, and then proceeds to STEP S13.

In STEP S13, if the user (the teacher) designates a title by a user's (teacher's) operation, in response to that operation, the control unit 11 performs preview display on the touch panel type display unit 14.

In other words, in response to a user's (teacher's) operation for seeing titles existing in the next screen, the next screen is displayed.

Then, if the user (the teacher) selects a character string of a title for a question as shown in FIG. 4 by touching the touch panel type display unit 14 with a touch pan, the control unit 11 loads the selected character string sequence as a title for a question, in STEP S14, and registers the character string of the title for a question, together with order information, in selected-character-string data (a question list) of the work area 123 of the storage unit 12, and proceeds to STEP S16.

In STEP S16, the control unit 11 performs display for inquiring the user (the teacher) about whether to continue selecting a character string of a title, on the touch panel type display unit 14, and waits for a user's (teacher's) operation.

Then, if the user (the teacher) determines to continue (“YES” in STEP S16), the control unit returns to STEP S13 again, and repeats the same procedure.

In the above described example, since four character strings are acquired in the order of (1) “DEATH OF SOCRATES”, (2) “KARELIA PEOPLE'S PLUNDER”, (3) “BATTLE OF LEUCTRA WITH THEBAE”, and (4) “ESTABLISHMENT OF CONSUL SYSTEM”, STEPS S13 to S15 are repeated only four times.

Meanwhile, if the user (the teacher) determines not to continue (“NO” in STEP S16), the control unit returns to STEP S11.

Thereafter, if the communication device 101 gets close to the student terminal 20, whereby short-range communication becomes possible, the result of STEP S24 of FIG. 10 becomes “YES”, and the control unit 11 proceeds to STEP S25 in which the control unit acquires the terminal ID of the partner (the student terminal 20) capable of short-range communication. Subsequently, in STEP S26, the control unit determines whether the student terminal 20 is a terminal having already received a question.

Specifically, the control unit 11 checks whether the record of the communication data of the work area 123 of the storage unit 12 represents that a question has been given, thereby performing the determination of STEP S26.

In a case of determining that a question has not been given, based on the record registered in the communication data, in STEP S27, the control unit 11 acquires the character strings of the titles for a question, from the selected-character-string data of the work area 123 of the storage unit 12, and randomly changes the sequence of the character strings. Subsequently, in STEP S28, the control unit registers the order information of the question list in the student-terminal-dependent sequence data of the work area 123 of the storage unit 12, in association with the terminal ID.

In other words, in the above described example, the control unit registers [1]<3>“DEATH OF SOCRATES (1)”, [2]<4>“KARELIA PEOPLE'S PLUNDER (2)”, [3]<1>“BATTLE OF LEUCTRA WITH THEBAE (3)”, and [4]<2>“ESTABLISHMENT OF CONSUL SYSTEM (4)” (student-terminal-dependent sequence data (correct order data)) which is the correct answer, in the student-terminal-dependent sequence data (question order data).

Subsequently, the control unit 11 transmits the question list as shown in FIG. 5, to the student terminal 20, in STEP S29, and then returns to STEP S11 again.

Subsequently, if the user (the teacher) brings the communication device 101 close to the student terminal 20 in order to obtain an answer from the student terminal 20, whereby short-range communication becomes possible, the result of STEP S24 becomes “YES” again, and as described above, STEPS S25 and S26 are sequentially performed.

At this stage, since short-range communication has been established for obtaining an answer, the student terminal 20 capable of short-range communication can be considered as having received a question. However, in a case where the corresponding terminal has not received a question, the result of STEP S26 becomes “NO”, and a series of processes described above are performed.

At this stage, since short-range communication has been established for obtaining an answer, the result of STEP S26 becomes “YES”, and the control unit 11 proceeds to STEP S30 in which it determines whether it has been possible to information for obtaining a character string sequence of an answer from the student terminal 20.

In a case where it has not been possible to information for obtaining a character string sequence of an answer (answer order data) from the student terminal 20, the control unit 11 proceeds to STEP S37 in which it transmits data as shown in FIG. 8, as data to be displayed on the touch panel type display unit 24 of the student terminal 20. Subsequently, in STEP S35, the control unit performs display for inquiring the user (the teacher) about whether to display a list of the results of the individual terminals (the individual student terminals 20), on the touch panel type display unit 14, and waits a user's (teacher's) operation.

In a case where the user (the teacher) performs an operation for displaying the list of the results of the individual student terminals 20 (“YES” in STEP S35), in STEP S36, the control unit 11 displays the list of the correct-answer/incorrect-answer determination results of individual student terminals 20 which the control unit has at that moment, on the touch panel type display unit 14.

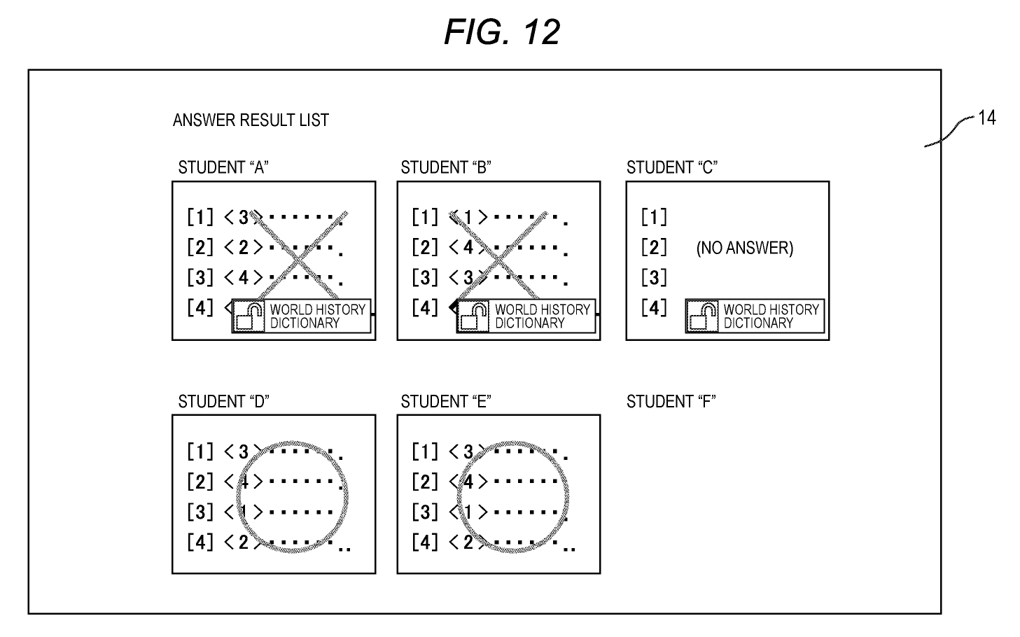

Also, since the sequence of the character strings is randomly changed for each student terminal 20 as described above, actually, correct answers are different from one another in the sequence. FIG. 12 shows the correct-answer/incorrect-answer determination results according to the above described example.

In the above described example, since the sequence of a correct answer is [1]<3>“DEATH OF SOCRATES (1)”, [2]<4>“KARELIA PEOPLE'S PLUNDER (2)”, [3]<1>“BATTLE OF LEUCTRA WITH THEBAE (3)”, and [4]<2>“ESTABLISHMENT OF CONSUL SYSTEM (4)”, as can be seen from the list display of FIG. 12, the answers of a student “A” and a student “B” are displayed as incorrect answers, and the answers of a student “D” and a student “E” are displayed as correct answers.

Also, in a case of a student “F”, since anything is not displayed, it can be seen that a process of receiving an answer has not been performed yet.

After the list is displayed in STEP S36, the control unit returns to STEP S11 again.

Even in a case where the user (the teacher) does not perform selection for displaying the list (“NO” in STEP S35), the control unit returns to STEP S11 again.

Meanwhile, in a case of determining in STEP S30 that it has been possible to receive information for obtaining a character string sequence of an answer (answer order data) from the student terminal 20, the result of STEP S30 becomes “YES”. Then, in STEP S31, based on the received information for obtaining the character string sequence of the answer, the control unit 11 performs correct-answer/incorrect-answer determination on the answer, and display the determination result on the touch panel type display unit 14. Subsequently, the control unit transmits the determination result to the student terminal 20 in STEP S32, and proceeds to STEP S33.

In STEP S33, the control unit 11 determines whether to transmit clues to unanswered portions and incorrect portions.

For example, if setting has been performed as a default such that, if there are unanswered portions and incorrect portions, the control unit transmits clues, the result of STEP S33 becomes “YES”. Then, in STEP S34, search permission information is transmitted, and on the touch panel type display unit 24 of the student terminal 20, display as shown in FIG. 7 is performed such that information representing that world history dictionary search has been permitted.

However, whether to transmit search permission information does not necessarily need to be set as a default, and may be set in the stage of STEP S33 by a user's (teacher's) operation.

Subsequently, the control unit returns to STEP S11 again through some steps such as STEP S35.

Meanwhile, in some cases such as a case where the answer of the student terminal 20 is correct, or setting for providing clues has not been performed as a default, the result of STEP S33 becomes “NO”, and thus the control unit does not transmit search permission information. In other words, the control unit returns to STEP S11 again through some steps such as STEP S35, without proceeding to STEP S34.

Meanwhile, if any other function is selected, the result of STEP S38 becomes “YES”, and the control unit 11 performs a corresponding process.

The series of operations of the communication device 101 are as described above. Now, the operations of the student terminal 20 will be described with reference to FIG. 11.

(Operation of Student Terminal)

As shown in FIG. 11, if the operation starts, in STEP S51, the control unit 21 of the student terminal 20 determines whether short-range communication has been detected. In a case where short-range communication has not been detected (“NO” in STEP S51), the control unit 21 proceeds to STEP S62 in which it determines whether any other function has been selected. In a case where any other function has not been selected (“NO” in STEP S62), the control unit 21 returns to STEP S51 again, and determines whether short-range communication has been detected.

In other words, the control unit 21 becomes a state in which it waits for any one event of detection of short-range communication (STEP S51), and selection of any other function (STEP S62) to occur.

Then, if the user (the teacher) selects any other function by an operation, the result of STEP S62 becomes “YES”, and the control unit 21 performs a corresponding process.

Meanwhile, if short-range communication with the communication device 101 is detected, the result of STEP S51 becomes “YES”, and the control unit 21 proceeds to STEP S52 in which it determines whether character strings of question data, that is, character strings rearranged randomly (or question order data and data on the plurality of selected character strings) have been received.

In a case where character strings rearranged randomly (or question order data and data on the plurality of selected character strings) have been received as character strings of question data (“YES” in STEP S52), the control unit 21 proceeds to STEP S53 in which it registers the order in which the character strings rearranged randomly have been received, as order information (question order data), in the question list area (the work area 223 of the storage unit 22). Subsequently, in STEP S54, the control unit displays the question data on the touch panel type display unit 24 as shown in FIG. 5. Then, in STEP S55, the control unit waits for user's (student's) operations.

Then, if user's (teacher's) operations are performed, the control unit loads answer (order information) inputs according to the operations, and registers the order information as information (answer order data) for obtaining the character string sequence of the answer, in the communication data of the work area 223 of the storage unit 22, and returns to STEP S51.

Thereafter, if the communication device 101 gets close to the student terminal, whereby short-range communication becomes possible, the information (answer order data) usable for obtaining the character string sequence of the answer and stored in the communication data is transmitted to the communication device 101.

Meanwhile, if the next short-range communication is established before the registration finishes, since the communication device 101 cannot receive the information for obtaining the character string sequence of the answer, in the communication device 101, it is determined that it has been impossible to receive any answer (see the student “C” of FIG. 12).

Meanwhile, in a case of determining in STEP S52 that question data has not been received (“NO” in STEP S52), the control unit 21 proceeds to STEP S56 in which it determines whether a correct-answer/incorrect-answer determination result has been received.

If a correct-answer/incorrect-answer determination result has been received, the result of STEP S56 becomes “YES”, and the control unit proceeds to STEP S57 in which it controls the touch panel type display unit 24 such that the display unit displays the correct-answer/incorrect-answer determination result as shown in FIG. 7, and then proceeds to STEP S58.

In STEP S58, based on the correct-answer/incorrect-answer determination result, the control unit 21 determines whether there is any unanswered portion or incorrect portion.

In a case where the answer is correct, the result of STEP S58 becomes “NO”, and the control unit returns to STEP S51 again. Meanwhile, in a case where the answer is incorrect, the result of STEP S58 becomes “YES”, and the control unit proceeds to STEP S59.

Also, even if the control unit proceeds to STEP S56, in a case where it has been impossible to receive a correct-answer/incorrect-answer determination result, the control unit proceeds to STEP S59.

Also, in some cases such as a case where any answer has not transmitted, even if the control unit proceeds to STEP S56, a case where it is impossible to receive a correct-answer/incorrect-answer determination result occurs.

In STEP S59, the control unit 21 determines whether clue information, that is, search permission information has been received.

In a case where clue information has not received, the result of STEP S59 becomes “NO”, and the control unit 21 performs any other process (such as error processing). Meanwhile, in a case where clue information has been received, the result of STEP S59 becomes “YES”, and the control unit performs setting for displaying the clue information, that is, setting for permitting access to the world history dictionary, and displays information representing that access to the world history dictionary has been permitted, on the lower right side of the correct-answer/incorrect-answer determination result displayed on the touch panel type display unit 24, as shown in FIG. 7.

Subsequently, in STEP S61, the control unit 21 controls the touch panel type display unit 24 such that the display unit displays description information and the like related to the character strings of the titles of the question in response to user's (student's) operations. If a series of user's (student's) operations finish, the control unit returns to STEP S51 again.

The series of operations of the student terminal 20 have been described above. Hereinafter, the effects of the first embodiment will be described.

According to the communication device 101 of the present embodiment, the user (the teacher) needs only to touch items (the titles of world history events) from the world history dictionary displayed on the touch panel type display unit 14, for acquiring the character strings of the titles and registering the sequence of the character strings,

Also, in a case of transmitting the character strings to a student terminal 20, the communication device 101 randomly changes the sequence of the character strings, and transmits the rearranged character strings as a question to the student terminal 20. Therefore, it is possible to very easily set a question.

Further, since the communication device 101 records order data (terminal-dependent correct order data) for performing correct-answer/incorrect-answer determination, in association with the terminal ID of the student terminal 20, the user (the teacher) needs only to bring the communication device 101 close to the student terminal 20 in order to obtain an answer from the student. Then, the communication device 101 automatically performs correct-answer/incorrect-answer determination. Therefore, it is possible to save the user's (teacher's) trouble of checking whether the answer is correct or not.

Also, since the process of automatically changing the sequence of the character strings (the process of generating and registering terminal-dependent question order data) is performed whenever the control unit transmits the character strings to each student terminal 20, the correct sequences of problems assigned to the individual students do not coincide with each other. Therefore, even if a student cheats off a neighboring student, the answer is incorrect. Therefore, it is possible to prevent cheating.

Also, in a case of a communication mode in which communication is performed in a relatively wide range, in a case of changing the timing to obtain each answer based on the progress of a corresponding student, in order to acquire a desired answer, a setting operation like an operation of designating the student terminal 20 of a corresponding student is required. However, in a case of short-range communication, if the communication device is directly brought closest to a student terminal 20, communication becomes possible. Therefore, in order to acquire a desired answer, the user needs only to bring the communication device 101 close to the student terminal 20 of a corresponding student, and does not need to perform a setting operation like an operation of designating the student terminal 20 of the corresponding student.

Further, a student which makes rapid progress can bring the student terminal 20 close to the communication device 101 in person, and proceeds to the next assignment.

Therefore, it is possible to improve the efficiency of teaching and learning.

### Second Embodiment

In the first embodiment, the case where a question to be given is a world history question has been described. However, a question which is given by the communication device 101 of the present invention is not limited to the world history, and may be an English question.

Therefore, in a second embodiment, a case where a question to be given is an English question will be described.

The present embodiment is different from the first embodiment in that, in specific processing, data which is read from the data area 122 in order to set a question is not data of the world history dictionary but English text data, and the basic processing content of the present embodiment is the same as that the first embodiment. Therefore, portions of the second embodiment identical to those of the first embodiment will not be described. Also, in the present embodiment, a case where the communication device 101 and a student terminal 20 (a terminal) are tablet terminals, respectively, is assumed.

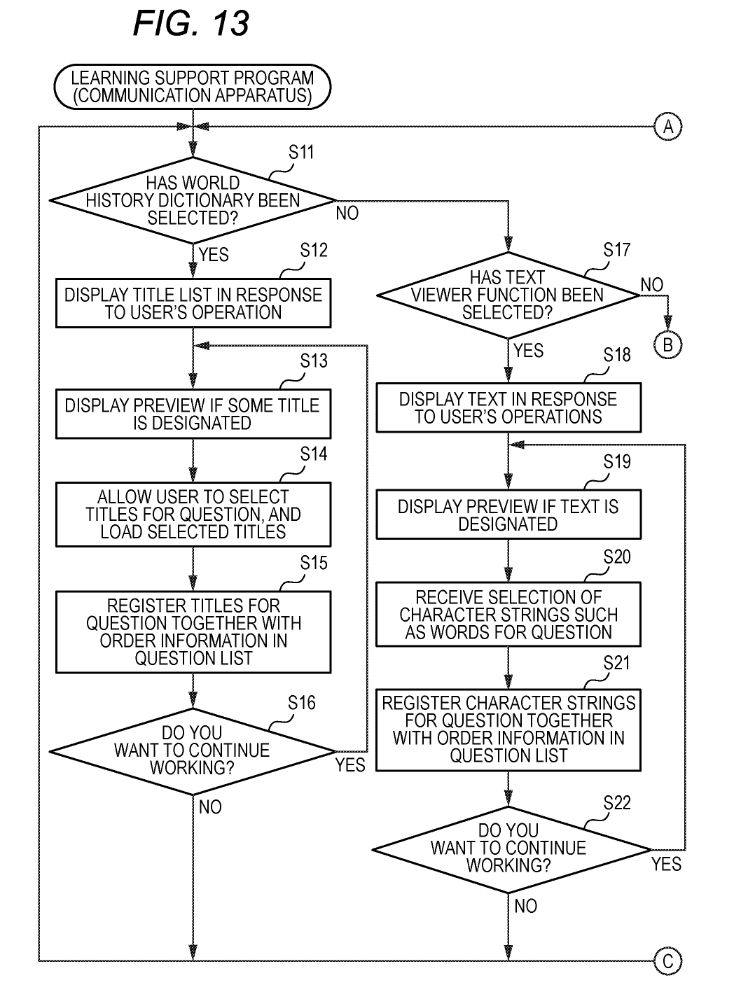

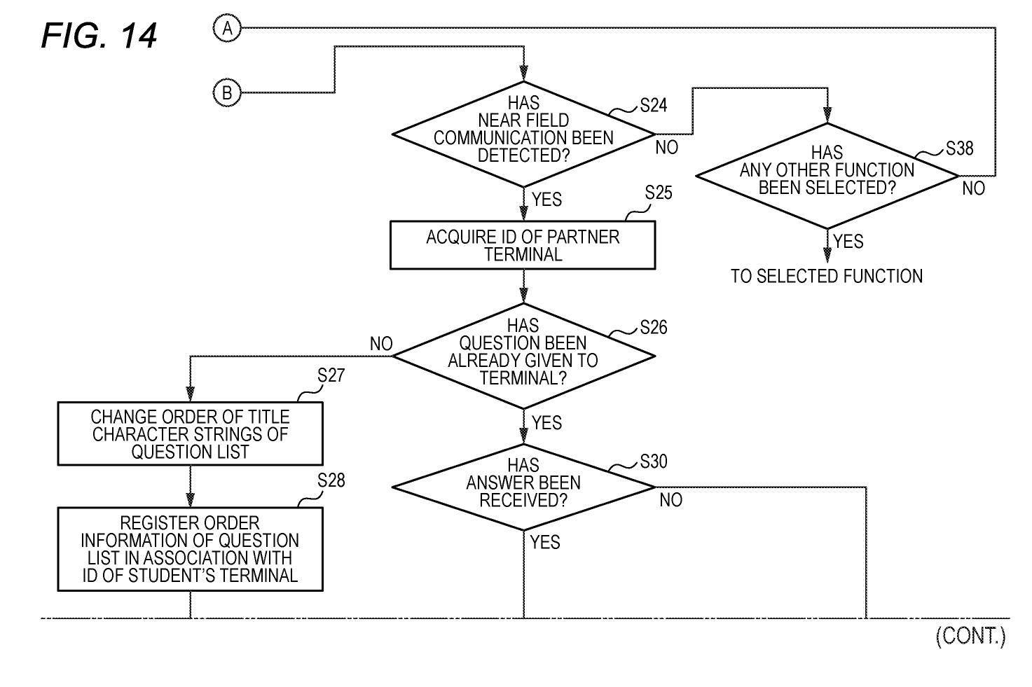

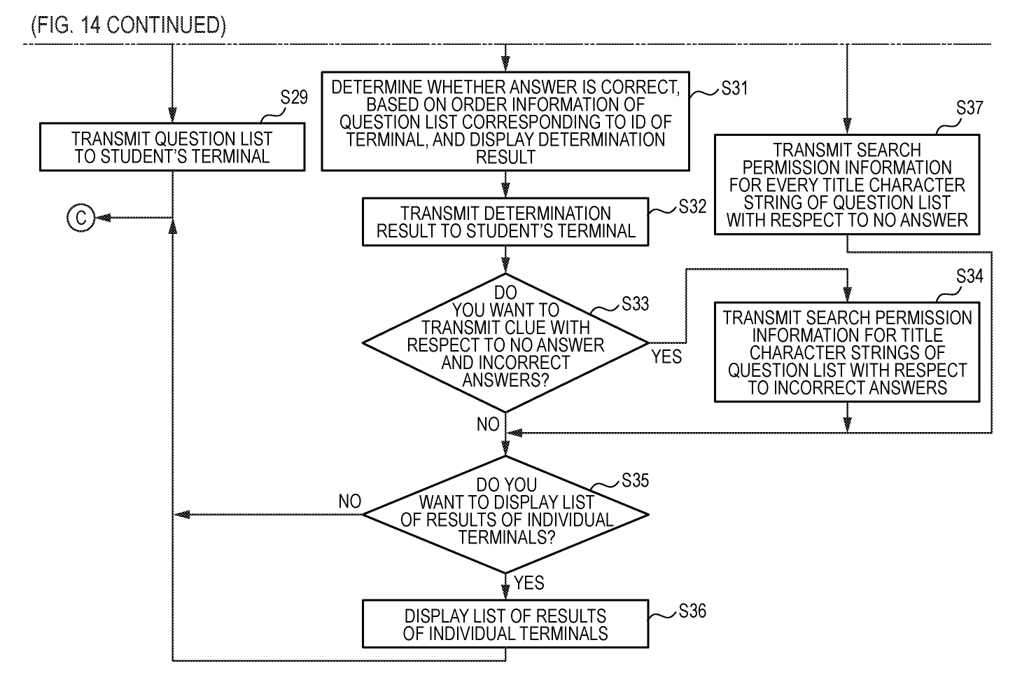

FIGS. 13 and 14 are flow charts obtained by adding a flow chart portion representing the operation of the second embodiment to the flow charts of the operations of the first embodiment.

Specifically, as a portion representing the operation of the second embodiment, STEPS S17 to S22 have been added.

However, the processing content of a procedure of setting a question is substantially the same as that in the case of setting a world history question.

Hereinafter, the operation of the second embodiment will be described with reference to the flow charts.

If the operation of the communication device 101 starts, the control unit 11 repeats determinations of STEPS S11, S17, S24, and S38 in this order until the result of any one step becomes “YES”.

In other words, the control unit 11 becomes a state in which it waits for the event of any one step to occur.

In this state, if the user (the teacher) performs an operation of selecting a text viewer function in order to set an English question, the result of STEP S17 becomes “YES”, and the control unit proceeds to STEP S18.

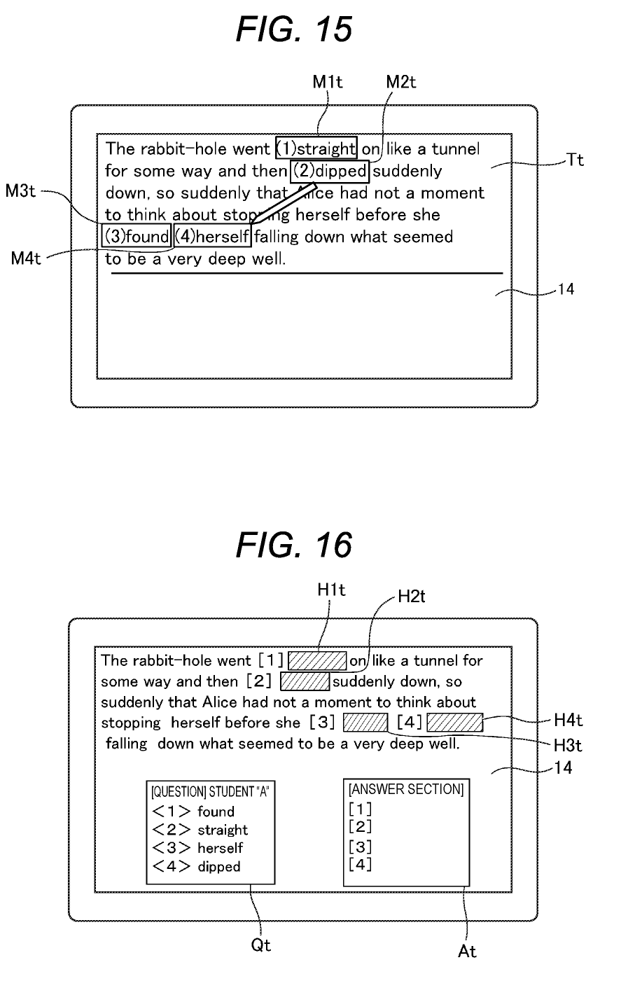

In STEP S18, if the user (the teacher) performs an operation for displaying an English text, the control unit 11 controls the touch panel type display unit 14 such that the display unit displays the selected English text as shown in FIG. 15, and proceeds to STEP S19.

In STEP S19, if the user (the teacher) designates texts by user's (teacher's) operation, in response to those operations, the control unit 11 controls the touch panel type display unit 14 such that the display unit displays the learning object texts.

For example, in FIG. 15, an English text Tt is displayed in one screen.

In a case of a longer sentence or the like, it may be impossible to display the text in one screen. In this case, in response to a user's (teacher's) operation, display of the text of the next screen is performed.

Then, if the user (the teacher) selects a character string such as a word for a question by touching the touch panel type display unit 14 with a touch pan, the control unit 11 loads the selected character string as a character string for a question, in STEP S14, and registers the character string for a question, together with order information, in selected-character-string data (a question list) of the work area 123 of the storage unit 12, and proceeds to STEP S22.

For example, since this time is the first character string selection, (1) straight (M1t) is registered.

Subsequently, in STEP S22, the control unit 11 performs display for inquiring the user (the teacher) about whether to continue selecting a character string, on the touch panel type display unit 14, and waits for a user's (teacher's) operation.

In the example shown in FIG. 15, since (2) dipped (M2t), (3) found (M3t), and (4) herself (M4t) are selected, the user (the teacher) determines to continue, and returns to STEP S19 again, and repeats the same procedure three times.

Then, in STEP S22 which is performed for the fourth time, the user determines not to continue. As a result, the result of STEP S22 becomes “NO”, and the control unit returns to STEP S11.

As described above, similarly in the first embodiment, four character strings, (1) straight (M10, (2) dipped (M2t), (3) found (M3t), and (4) herself (M4t) are registered in the selected-character-string data.

Specifically, the character strings selected by the user (the teacher), and predetermined order data (correct order data (1) to (4)) are stored in association with each other. At this time, the predetermined order data may be registered as data on the display order of the selected character strings in text. Therefore, even if the user (the teacher) selects character strings in the order from top to bottom, correct order data is registered appropriately for the sequence.

Therefore, if the user brings the communication device 101 close to a student terminal 20 in order to give a question, processes identical to STEPS S24, S25, S26, S27, S28, and S29 described in the first embodiment are performed.

In other words, similarly in the first embodiment, the control unit 11 randomly changes the sequence of the character strings, for example, like <1>“found (3)”, <2>“straight (1)”, <3>“herself (4)”, and <4>“dipped (2)”, and registers the correct answer, [1] <2>“straight (1)”, [2]<4>“dipped (2)”, [3]<1>“found (3)”, and [4]<3>“herself (4)”, as terminal-dependent question order data, in the student-terminal-dependent sequence data of the work area 123 of the storage unit 12, and gives the question to the student terminal 20.

FIG. 16 shows a state where information to be give to the student terminal 20 is displayed on the communication device 101 of the teacher.

In the English text Tt, the text in which the selected character string portions “straight (H1t)”, “dipped (H2t)”, “found (H3t)”, and “herself (H4t) have been hidden is displayed as a portion of question data.

Also, the character strings Qt rearranged in the question order for the student “A” is displayed, and an answer section At to be transmitted to the student is displayed together.

After confirming that content, the teacher can transmit the question data to the student.

Thereafter, if the user brings the communication device 101 to the student terminal 20 in order to receive an answer (answer order data) from the student terminal 20, processes identical to STEPS S24, S25, S26, and S30 to S36 described in the first embodiment are performed.

Further, similarly in the first embodiment, the communication device 101 transmits the correct-answer/incorrect-answer determination result to the student terminal 20. In a case where there is any unanswered portion or incorrect portion, the communication device transmits search permission information to the student terminal, thereby permitting access to an English dictionary, such that the student can search for and browse the words (the character strings) in the English dictionary.

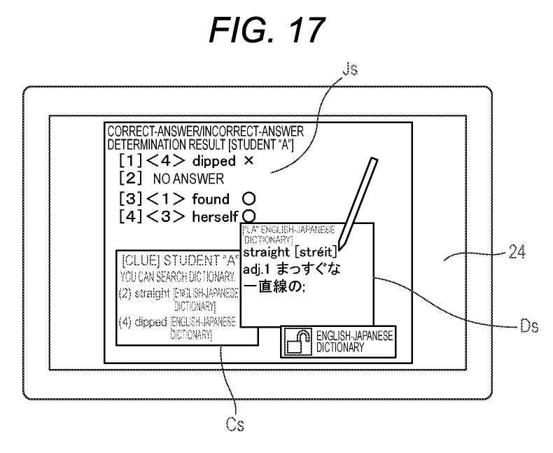

FIG. 17 shows an example of the touch panel type display unit 24 in a state where it is possible to search for and browse the words (the character strings) in the English dictionary on the student terminal 20.

The correct-answer/incorrect-answer determination result (Js) is displayed, and clue display Cs permitting dictionary search with respect to the incorrect portion “dipped” and the unanswered portion “straight” is performed.

Also, in response to a student's operation, dictionary description information Ds of “straight” is displayed.

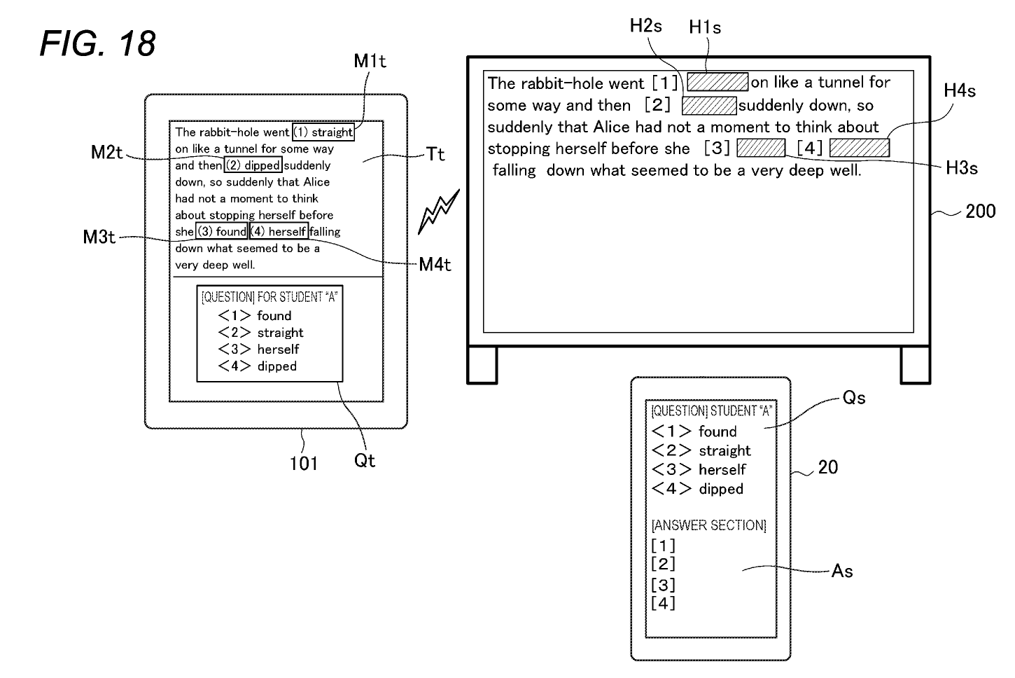

Also, as shown in FIG. 18, the communication device 101 may transmit the question to an electronic blackboard 200 which is a display device installed to be viewable from the location of the student terminal 20, such that the question (and the text of the question) is displayed on the electronic blackboard 200.

In this case, the control unit 11 of the communication device 101 functions as a means for transmitting the text including the hidden character strings, thereby transmitting the text in which the character strings ((1) straight (M10, (2) dipped (M20, (3) found (M30, and (4) herself (M40) selected from the text displayed on the touch panel type display unit 14 has been hidden, to the electronic blackboard 200 which is a display device installed to be viewable from the location of the student terminal 20, through the near field communication unit 15.

According to this configuration, it is unnecessary to mark the question texts to be transmitted to the student terminal 20, and the student can input answers in an answer section As of the student terminal 20 while seeing the text and the marked portions (H1s to H4s) displayed on the electronic blackboard 200.

Further, instead of transmitting the question to the electronic blackboard 200 such that the question is displayed on the electronic blackboard 200, the communication device 101 may transmit the marked question texts, to the student terminal 20, such that the marked question texts are displayed on the student terminal 20.

In other words, when the communication device transmits the question list to the student terminal 20 in STEP S29 of FIG. 14, it may transmit marked question texts.

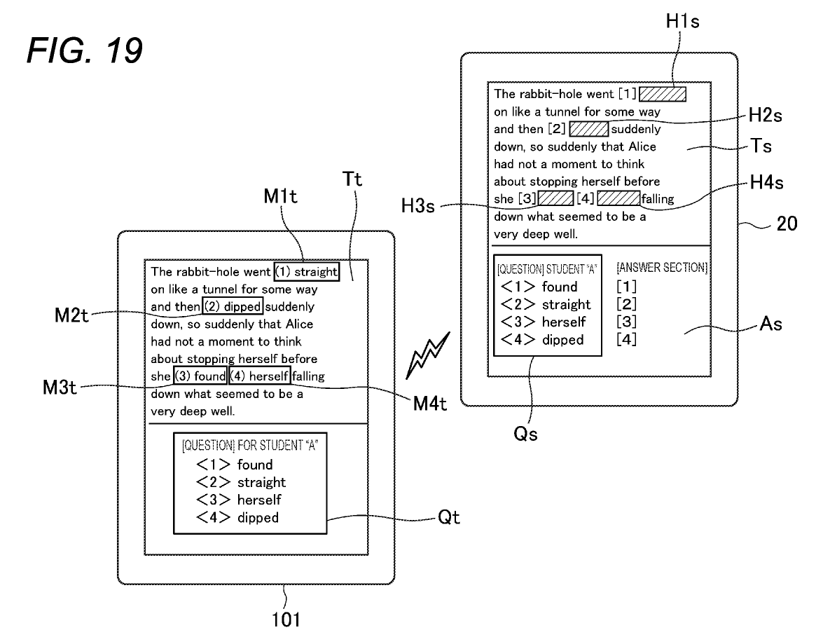

In this case, the control unit 11 of the communication device 101 functions not only as a character-string transmitting means for transmitting the rearranged character strings (question order data) to the student terminal 20 through the near field communication unit 15, but also as a means for transmitting the text including the hidden character strings, that is, the text in which the character strings ((1) straight, (2) dipped, (3) found, and (4) herself) selected from the text displayed on the touch panel type display unit 14 has been hidden, thereby capable of making it possible for the student terminal 20 to perform display as shown in FIG. 19.

Although the communication device 101 of the present invention has been described based on the specific embodiments, the present invention is not limited to the specific embodiments.

For example, in the embodiments, the case where the near field communication unit 15 uses NFC has been described. However, the near field communication unit 15 may use Bluetooth (a trademark), Wi-Fi (a trademark), or the like.

Also, in the embodiments, as a world history question, a question about rearranging events in chronological order is set. However, any other question such as a question about arranging events in order of importance. Also, it goes without saying that a question field is not particularly limited, and may be world history, Japanese history, geography, chemistry, biology, and the like.

As described above, the present invention is not limited to the specific embodiments, and various changes and modifications thereof can also be included in the technical scope of the present invention. This is apparent to those skilled in the art from claims.

What is claimed is:

1. A communication method of a communication device including a display and a communication unit which communicates with a terminal, the communication method comprising:
registering (i) a plurality of character string data items selected from text data displayed on the display by user's operations, and (ii) correct order data which is selection order data of the plurality of character string data items, in association with each other;
generating order data which is different from the registered correct order data in the order, as question order data of the plurality of selected character string data items;
transmitting the generated question order data and the plurality of selected character string data items, in association with each other, to a terminal by the communication unit;
receiving answer order data which is order data of answers to the plurality of selected character string data items, from the terminal by the communication unit; and
determining the received answer order data based on the registered correct order data.

2. The communication method according to claim 1, wherein:
in the registering, the plurality of selected character string data items, and order data on a position order of the plurality of selected character string data items in a text of the text data are registered in association with each other.

3. The communication method according to claim 1, wherein:
in the transmitting, character string data items obtained by rearranging the plurality of selected character string data items in the order of the question order data are transmitted; and
the communication method further comprises:
outputting a determination result.

4. The communication method according to claim 1, wherein:
in the generating, order data on an order depending on each of a plurality of terminals is generated as question order data of the plurality of selected character string data items.

5. The communication method according to claim 1, further comprising:
transmitting text data obtained by hiding the plurality of selected character string data items of the text data.

6. The communication method according to claim 5, wherein:
in the transmitting of the text data, the text data obtained by hiding the plurality of selected character string data items is transmitted to the terminal.

7. The communication method according to claim 5, wherein:
in the transmitting of the text data, the text data obtained by hiding the plurality of selected character string data items is transmitted to a display device which is viewable from a location of the terminal.

8. The communication method according to claim 1, further comprising:
transmitting search permission information of the character string data items to the terminal.

9. A communication device comprising:
a display;
a communication unit which communicates with a terminal; and
a processor,
wherein the processor is configured to:
register (i) a plurality of character string data items selected from text data displayed on the display by user's operations, and (ii) correct order data which is selection order data of the plurality of character string data items, in association with each other;
generate order data which is different from the registered correct order data in the order, as question order data of the plurality of selected character string data items;
transmit the generated question order data and the plurality of selected character string data items, in association with each other, to a terminal by the communication unit;
receive answer order data which is order data of answers to the plurality of selected character string data items, from the terminal by the communication unit; and
determine the received answer order data based on the registered correct order data.

10. The communication device according to claim 9, wherein:
the processor is configured such that, in the registering, the plurality of selected character string data items, and order data on a position order of the plurality of selected character string data items in a text of the text data are registered in association with each other.

11. The communication device according to claim 9, wherein:
in the transmitting, character string data items obtained by rearranging the plurality of selected character string data items in the order of the question order data are transmitted; and
the processor is further configured to:
output a determination result.

12. The communication device according to claim 9, wherein:
in the generating, order data on an order depending on each of a plurality of terminals is generated as question order data of the plurality of selected character string data items.

13. The communication device according to claim 9, wherein:
the processor is further configured to:
transmit text data obtained by hiding the plurality of selected character string data items of the text data.

14. The communication device according to claim 13, wherein:
in the transmitting of the text data, the text data obtained by hiding the plurality of selected character string data items is transmitted to the terminal.

15. The communication device according to claim 13, wherein:
in the transmitting of the text data, the text data obtained by hiding the plurality of selected character string data items is transmitted to a display device which is viewable from a location of the terminal.

16. The communication device according to claim 9, wherein:
the processor is further configured to:
transmit search permission information of the character string data items to the terminal.

17. A non-transitory computer readable storage medium having stored therein instructions, which when executed by a device including a display, a memory, a communication unit which communicates with a terminal, cause the device to:
register (i) a plurality of character string data items selected from text data displayed on the display by user's operations, and (ii) correct order data which is selection order data of the plurality of character string data items, in association with each other;
generate order data which is different from the registered correct order data in the order, as question order data of the plurality of selected character string data items;
transmit the generated question order data and the plurality of selected character string data items, in association with each other, to a terminal by the communication unit;
receive answer order data which is order data of answers to the plurality of selected character string data items, from the terminal by the communication unit; and
determine the received answer order data based on the registered correct order data.
